(19) United States
(12) Patent Application Publication
(10) Pub. No.: US 2008/0113688 A1
(43) Pub. Date: May 15, 2008

(54) MOBILE COMMUNICATION TERMINAL AND METHOD OF DISPLAYING INFORMATION USING AN INFORMATION DISPLAY FUNCTION

(75) Inventors: Sang Hyuck Lee, Seoul (KR); Min Hun Kang, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/940,243

(22) Filed: Nov. 14, 2007

(30) Foreign Application Priority Data
Nov. 14, 2006 (KR) 10-2006-0112157

(51) Int. Cl. H04B 1/38

(52) U.S. Cl. 455/566

(57) ABSTRACT

A mobile communication terminal and method of displaying information using an information display function are provided in which at least one of a gravitational motion of a display unit and a rotational motion of a display unit is detected. An information display direction is adjusted according to the detected motion. The present invention includes a display unit configured to display information, a detecting unit configured to detect at least one of a gravitational direction of the display unit and a rotational direction of the display unit and a control unit configured to adjust a display direction of the information displayed on the display unit using the at least one of the detected gravitational direction and the rotational direction.

This application claims the priority benefit of the Korean Patent Application No. 10-2006-0112157, filed on Nov. 14, 2006, which is hereby incorporated by reference as if fully set forth herein.

### FIELD OF THE INVENTION

The present invention is directed to a mobile communication terminal, and specifically to a mobile communication terminal and method of displaying information using an information display function

### DISCUSSION OF THE RELATED ART

Generally, in a related art mobile communication terminal, information is always displayed in the same display orientation regardless of a rotational motion of the mobile communication terminal or a display unit provided in the mobile communication terminal. Therefore, a user of the mobile communication terminal is always provided with information displayed in a direction parallel with a horizontal direction of a display window regardless of the rotation or a degree of the rotation when the mobile communication terminal or the display unit is rotated.

In a related art mobile communication terminal, the fact that the terminal is rotated or a degree of the rotation is not taken into consideration when displaying information. Therefore, a user has difficulty in recognizing information if the display unit is rotated because the mobile communication terminal always displays information in a direction parallel with the horizontal direction of the display window. Furthermore, a related art mobile communication terminal fails to provide a user with size-significant information, such as battery consumption and available memory.

### SUMMARY OF THE INVENTION

In one aspect of the present invention, a mobile communication terminal having an information display function is provided. The mobile communication terminal includes a display unit displaying information, a detecting unit detecting at least one of a gravitational direction of the display unit and a rotational direction of the display unit and a control unit adjusting a display direction of the information displayed on the display unit using the at least one of the gravitational direction and the rotational direction detected by the detecting unit.

It is contemplated that the mobile communication terminal further includes a measuring unit measuring at least one of remaining battery quantity, remaining memory quantity, call reception sensitivity, network reception sensitivity, amount of data downloaded and broadcast reception sensitivity. It is further contemplated that the control unit controls the display unit to display an indication of a size of the measurement performed by the measuring unit as the information displayed by the display unit.

It is contemplated that the detecting unit includes a sensor detecting the at least one of the gravitational direction and the rotational direction. It is further contemplated that the sensor includes at least one of a gravity detecting sensor, a rotation detecting sensor and a gyro-sensor.

It is contemplated that the control unit adjusts the display direction of the information displayed on the display unit in a direction vertical to the detected gravitational direction. It is further contemplated that the control unit adjusts the display direction of the information displayed on the display unit in a direction opposite to the detected rotational direction.

It is contemplated that the control unit adjusts the display direction according to a detected rotational angle. It is further contemplated that the information displayed by the display unit includes at least one of a list of menu items, a character message, a data list, a moving picture and a still picture.

In another aspect of the present invention, a method of displaying information in a mobile communication terminal is provided. The method includes detecting at least one of a gravitational direction of a display unit and a rotational direction of a display unit and adjusting a display direction of information displayed on the display unit using the detected at least one of the gravitational direction and the rotational direction.

It is contemplated that the method further includes setting an information display function according to a motion direction. It is further contemplated that the method further includes measuring at least one of remaining battery quantity, remaining memory quantity, call reception sensitivity, network reception sensitivity, amount of data downloaded and broadcast reception sensitivity.

It is contemplated that the method further includes displaying an indication of a size of the measurement performed as the information displayed on the display unit. It is further contemplated that detecting the at least one of the gravitational direction and the rotational direction includes controlling a sensor.

It is contemplated that the display direction of the information displayed on the display unit is adjusted in a direction vertical to the detected gravitational direction. It is further contemplated that the display direction of the information displayed on the display unit is adjusted in a direction opposite to the detected rotational direction.

It is contemplated that the display direction of the information is adjusted according to an angle of detected rotation. It is further contemplated that the information displayed on the display unit includes at least one of a list of menu items, a character message, a data list, a moving picture and a still picture.

In another aspect of the present invention, a method of displaying information in a mobile communication terminal is provided. The method includes setting an information display function according to a motion direction, displaying an indication of a size of a measurement performed on a display unit, detecting at least one of a gravitational direction of the display unit and a rotational direction of the display unit and adjusting a display direction of the indication displayed on the display unit using the detected at least one of the gravitational direction and the rotational direction.

It is contemplated that the display direction of the indication is adjusted in one of a direction vertical to the detected gravitational direction and a direction opposite to the detected rotational direction.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile communication terminal having an information display function according to one embodiment of the present invention.

FIG. 2 is a diagram illustrating a first example of displaying a size of measured information on a screen according to the present invention.

FIG. 3 is a diagram illustrating a second example of displaying a size of measured information on a screen according to the present invention.

FIG. 4 is a diagram illustrating a first example of displaying information in a display direction vertical to a gravitational direction according to the present invention.

FIG. 5 is a diagram illustrating a second example of displaying information in a display direction vertical to a gravitational direction according to the present invention.

FIG. 6 is a diagram illustrating a third example of displaying information in a display direction vertical to a gravitational direction according to of the present invention.

FIG. 7 is a flowchart of a method for displaying information in a mobile communication terminal according to one embodiment of the present invention.

FIG. 8 is a flowchart of a method for displaying information in a mobile communication terminal according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

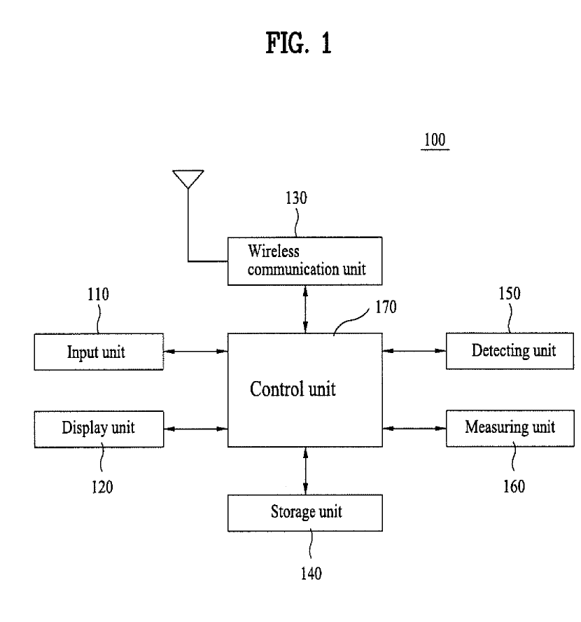

FIG. 1 is a block diagram of a mobile communication terminal 100 having an information display function according to one embodiment of the present invention. As illustrated in FIG. 1, the mobile communication terminal 100 includes an input unit 110, a display unit 120, a wireless communication unit 130, a storage unit 140, a detecting unit 150, a measuring unit 160 and a control unit 170.

The input unit 110 receives an input from a user and then generates a signal corresponding to the received input. The display unit 120 displays various types of information including status information of the mobile communication terminal 100. The wireless communication unit 130 transceives wireless signals with external terminals through a wireless network. The storage unit 140 stores all data input/output to/from the mobile communication terminal 100 and also stores programs required for operations of the respective elements of the mobile communication terminal. The detecting unit 150 detects at least one of a gravitational direction and a rotational direction of the display unit 120. The measuring unit 160 measures various types of information associated with operations or functions of the mobile communication terminal 100. The control unit 170 controls overall operations of the respective elements of the mobile communication terminal 100 by performing the programs stored in the storage unit 140.

Specifically, the input unit 110 generates a command signal for executing an information display function of the mobile communication terminal 100 according to a selection by a user. The information display function of the present invention refers to a function of adjusting a display direction of information displayed on the display unit 120 according to a degree or direction of rotation of the mobile communication terminal 100 or the display unit 120. Alternatively, the information display function of the present invention refers to a function of displaying an indication of a size of information measured by the measuring unit 160 on the display unit 120.

The detecting unit 150 includes a sensor for detecting at least one of gravitational direction and the rotational direction. For example, the sensor can include at least one of a gravity detecting sensor, a rotation detecting sensor and a gyro-sensor.

In a first process of the present invention, the measuring unit 160 measures at least one of remaining battery quantity, remaining memory quantity, amount of data downloaded, broadcast reception sensitivity, call reception sensitivity and network reception sensitivity. The control unit 170 generates an indicator of a size of the measured information that is displayed on the display unit 120 according to a size of the measured information. A user may set a pattern of the indicator.

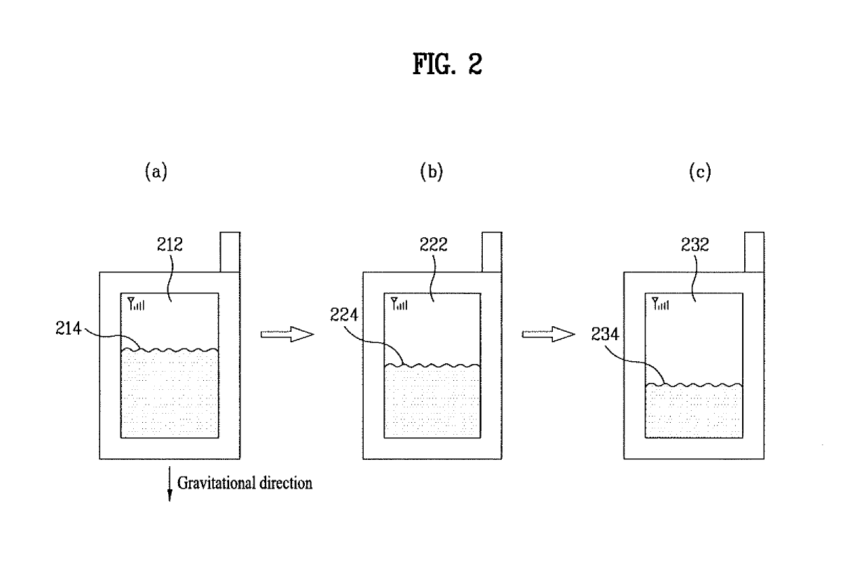

A first example of displaying measured information is illustrated in FIG. 2. As illustrated in FIG. 2, the measured information is the remaining battery quantity and the indicators 214, 224, 234 have wave patterns.

As illustrated in FIG. 2(a), the display unit 120 displays an indicator 214 indicating a size of the measured remaining battery quantity on a screen 212. Assuming that the entire size of the screen 212 indicates a maximum chargeable battery quantity (hereinafter ‘maximum battery quantity’), the indicator 214 can be regarded as indicating a currently remaining portion of maximum battery quantity (hereinafter ‘battery remaining quantity’).

It is contemplated that the remaining battery quantity can be represented using a portion of the screen 212 instead of using the entire screen. As the remaining battery quantity decreases, the display unit 120 displays indicators 224 and 234 indicating levels below the previous indicator 214 on, respectively, screens 222 and 232.

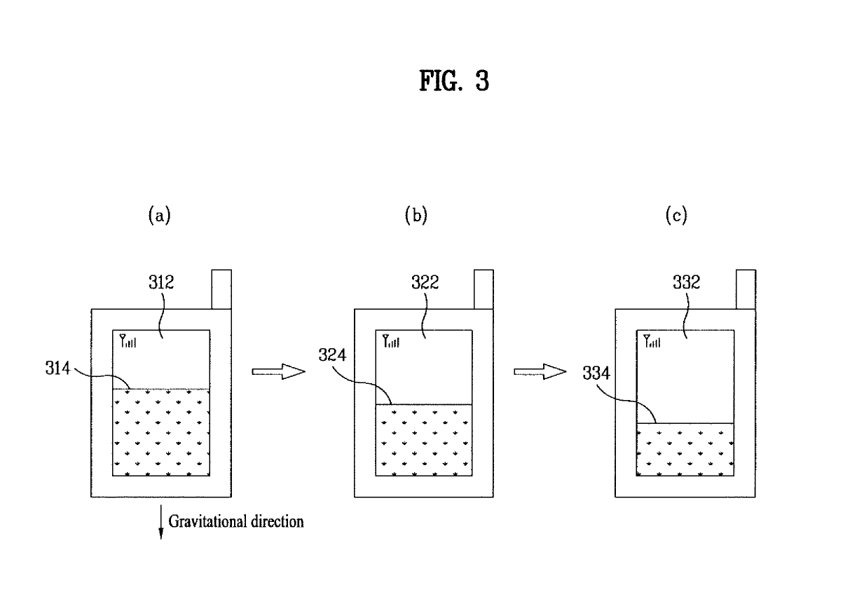

A second example of displaying measured information is illustrated in FIG. 3. As illustrated in FIG. 3, the measured information is the call reception sensitivity and the indicators 314, 324, 334 have arrow patterns.

As illustrated in FIG. 3(a), the display unit 120 displays an indicator 314 indicating a level of the measured call reception sensitivity on a screen 312. Assuming that the entire size of the screen 312 indicates a maximum level of available call reception sensitivity, the indicator 314 can be regarded as indicating a current call reception sensitivity level as a portion of the maximum size of the available call reception sensitivity.

It is contemplated that the call reception sensitivity can be represented using a portion of the screen 312 instead of using the entire screen. As the call reception sensitivity decreases, the display unit 120 displays indicators 324 and 334 indicating levels below the previous indicator 314 on, respectively, screens 322 and 332.

In a second process of the present invention, the control unit 170 adjusts a display direction of the indicator displayed on the display unit 120 using at least one of the gravitational and rotational directions detected by the detecting unit 150. For example, the control unit 170 is able to adjust the display direction of the indicator into a direction vertical to the detected gravitational direction.

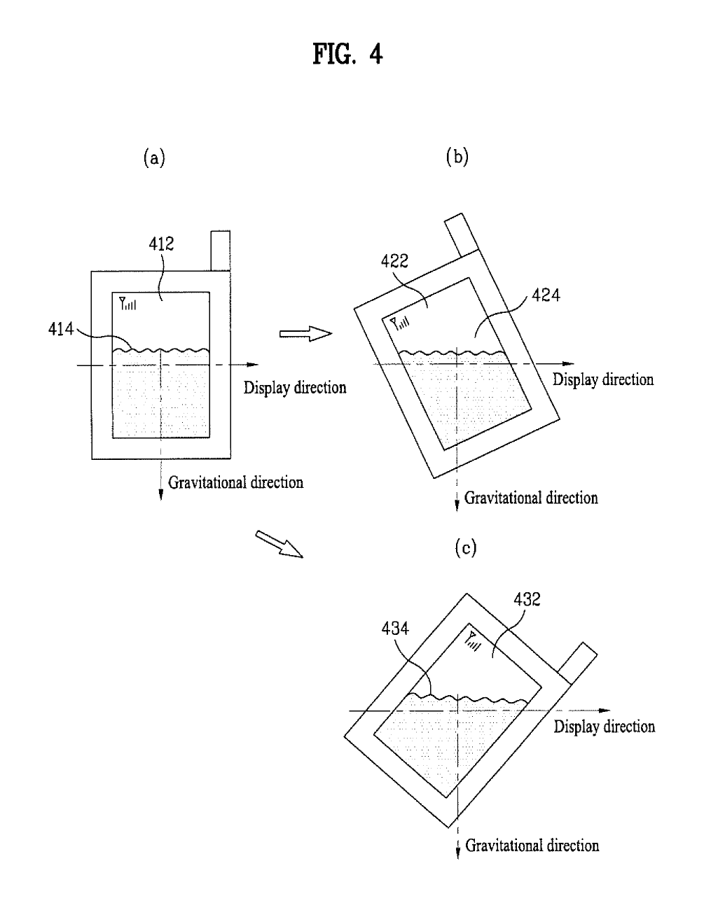

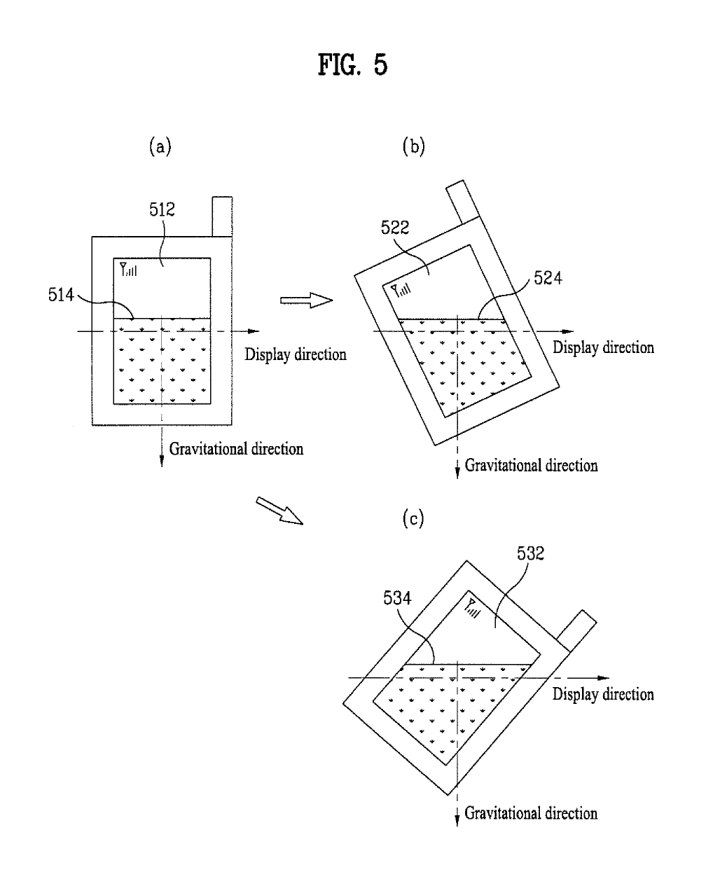

Two examples of adjusting a display direction of information are illustrated in FIGS. 4 and 5. FIG. 4 illustrates displaying the remaining battery quantity information in a display direction vertical to a gravitational direction. FIG. 5 illustrates displaying call reception sensitivity in a display direction vertical to a gravitational direction.

As illustrated in FIGS. 4(a) and 5(a), the display unit 120 displays indicators 414 and 514 on, respectively, screens 412 and 512 according to a display direction vertical to a gravitational direction detected by the detecting unit 150 when the display unit stays vertical to the horizontal plane. A user views displayed information as in the prior art.

As illustrated in FIGS. 4(b) and 5(b), the display unit 120 displays indicators 424 and 524 on, respectively, screens 422 and 522 according to a display direction vertical to a gravitational direction detected by the detecting unit 150 when the display unit inclines to the left. In this way, a user is provided with the displayed information inclined to the right as the display unit 120 inclines to the left.

As illustrated in FIGS. 4(c) and 5(c), the display unit 120 displays indicators 434 and 534 on, respectively, screens 432 and 532 according to a display direction vertical to a gravitational direction detected by the detecting unit 150 when the display unit inclines to the right. In this way, a user is provided with the displayed information inclined to the left as the display unit 120 inclines to the right.

The control unit 170 is also able to adjust a display direction of an indicator displayed on the display unit 120 in a direction opposite to a detected rotational direction. Specifically, if the detected rotational direction is 60° counterclockwise, the display direction of the indicator is inclined to 60° clockwise with reference to a horizontal direction of the display window of the display unit 120.

The control unit 170 adjusts a display direction of information displayed on the display unit 120 using at least one of gravitational and rotational directions detected by the detecting unit 150. The displayed information may include a list of menu items, a character message, a data list, a moving picture, or a still picture. It is contemplated that the present invention may be applied to any information displayable on the display unit 120.

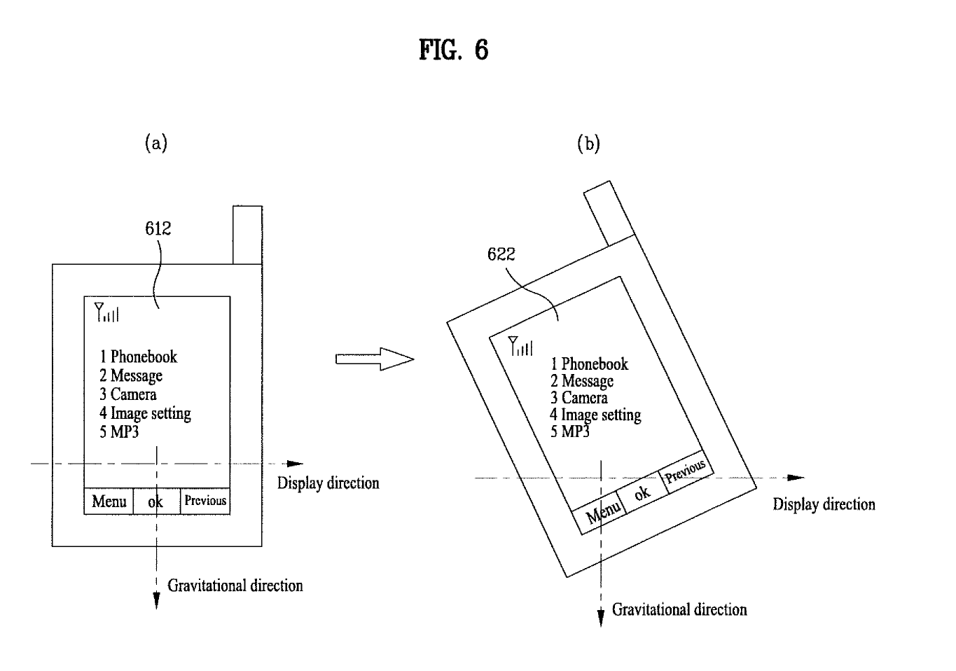

FIG. 6 is a diagram illustrating a third example of displaying information in a display direction vertical to a gravitational direction. As illustrated in FIG. 6, the display unit 120 displays a list of a plurality of menu items on a screen 612.

As illustrated in FIG. 6(a), the display unit 120 stays vertical to the horizontal plane and displays the list according to a display direction vertical to the gravitational direction. A user views the displayed information as in the prior art.

As illustrated in FIG. 6(b), the display unit 120 displays the list on a screen 622 according to a display direction vertical to the gravitational direction of the rotated direction when the mobile communication terminal or the display unit 120 is rotated. For example, the control unit 170 adjusts a display direction of the information displayed on the display unit 120 in a direction opposite to the detected rotational direction.

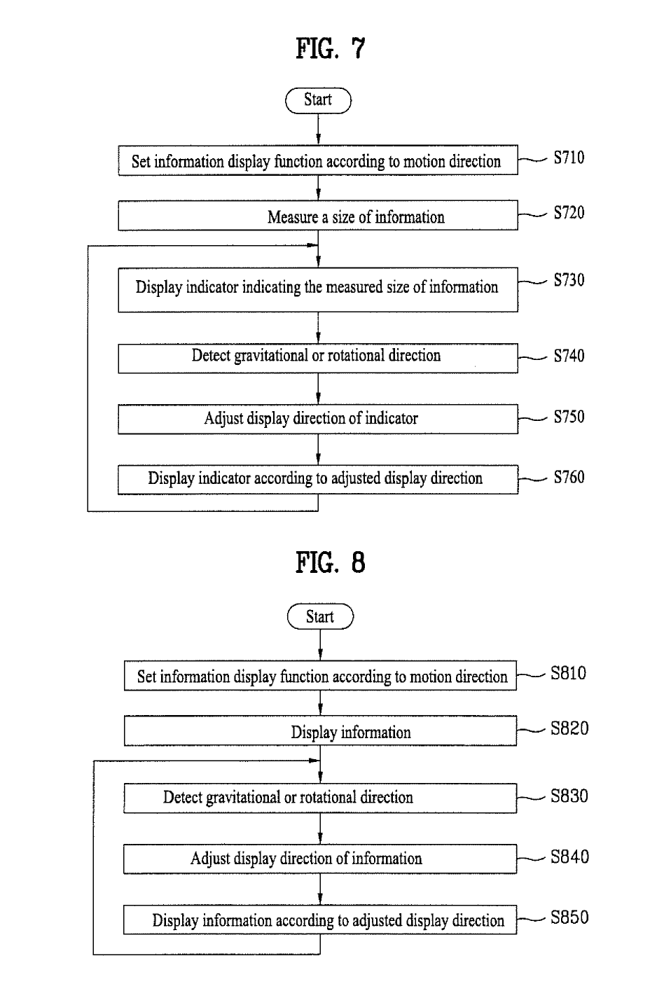

FIG. 7 is a flowchart of a method of displaying information in a mobile communication terminal 100 according to one embodiment of the present invention. As illustrated in FIG. 7, the mobile communication terminal 100 generates a command signal for executing an information display function of the present invention.

The mobile communication terminal sets the information display function depending on a motion direction according to the generated command signal (S710). Setting the information display function depending on the motion direction refers to adjusting a display direction of information displayed on the display unit 120 according to a rotational degree or rotational direction of the display unit. Alternatively, setting the information display function depending on the motion direction refers to displaying on the display unit 120 an indicator indicating a size of specific information measured by the mobile communication terminal 100.

Subsequently, the mobile communication terminal measures information (S720). For example, the mobile communication terminal 100 measures at least one of a remaining battery quantity, a remaining memory quantity, an amount of data downloaded, a broadcast reception sensitivity, a call reception sensitivity and a network reception sensitivity.

The mobile communication terminal 100 displays an indicator indicating the measured information on the display unit 120 (S730). The details of the measurement and display of an indicator were previously provided with regard to FIGS. 2 and 3.

The mobile communication terminal 100 detects at least one of gravitational and rotational directions 100 of the display unit 120 (S740). The mobile communication terminal 100 can use a sensor provided to measure the gravitational direction or the rotational direction.

The mobile communication terminal 100 adjusts a display direction of the indicator displayed on the display unit 120 using at least one of the detected gravitational and rotational directions (S750). For example, the mobile communication terminal 100 can adjust the display direction of the indicator in a direction vertical to the detected gravitational direction.

The details of the display adjustment were provided previously with respect to FIGS. 2 and 3. The mobile communication terminal 100 is able to adjust the display direction of the indicator in a direction opposite to a detected rotational direction.

FIG. 8 is a flowchart of a method of displaying information in a mobile communication terminal according to another embodiment of the present invention. As illustrated in FIG. 8, the mobile communication terminal 100 generates a command signal for executing an information display function of the present invention.

The mobile communication terminal 100 sets the information display function depending on a motion direction according to the generated command signal (S810). The mobile communication terminal 100 then displays information on a display unit 120 (S820). The displayed information refers to any information displayable on the display unit and may include a list of menu items, a character massage, a data list, a moving picture, or a still picture.

The mobile communication terminal 100 detects at least one of gravitational and rotational directions of the display unit 120 when rotation occurs (S830). The mobile communication terminal 100 then adjusts a display direction of the information displayed on the display unit 120 using at least one of the detected gravitational and rotational directions (S840).

For example, the mobile communication terminal 100 can adjust the display direction of the information displayed on the display unit 120 in a direction vertical to the detected gravitational direction. The mobile communication terminal 100 is able to adjust the display direction of the information displayed on the display unit 120 in a direction opposite to the detected rotational direction.

The present invention provides several effects or advantages that improve use convenience. First, the present invention is able to detect a gravitational direction and a rotational direction according to a rotational motion of a mobile communication terminal or a display unit. Second, the present invention is able to adjust a display direction of information according to a detected gravitational or rotational direction. Third, the present invention measures size-significant information, such as a remaining battery quantity, a remaining memory quantity, call reception sensitivity, a network reception sensitivity, or an amount of data downloaded and then provides the measured information.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are intended to be embraced by the appended claims.

The foregoing embodiments and advantages are merely exemplary and are not to be construed as limiting the present invention. The present teaching can be readily applied to other types of apparatuses.

The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A mobile communication terminal having an information display function, the mobile communication terminal comprising:
a display unit displaying information;
a detecting unit detecting at least one of a gravitational direction of the display unit and a rotational direction of the display unit; and
a control unit adjusting a display direction of the information displayed on the display unit using the at least one of the gravitational direction and the rotational direction detected by the detecting unit.

2. The mobile communication terminal of claim 1, further comprising:
a measuring unit measuring at least one of remaining battery quantity, remaining memory quantity, call reception sensitivity, network reception sensitivity, amount of data downloaded and broadcast reception sensitivity.

3. The mobile communication terminal of claim 2, wherein the control unit controls the display unit to display an indication of a size of the measurement performed by the measuring unit as the information displayed by the display unit.

4. The mobile communication terminal of claim 1, wherein the detecting unit comprises a sensor detecting the at least one of the gravitational direction and the rotational direction.

5. The mobile communication terminal of claim 4, wherein the sensor comprises at least one of a gravity detecting sensor, a rotation detecting sensor and a gyro-sensor.

6. The mobile communication terminal of claim 1, wherein the control unit adjusts the display direction of the information displayed on the display unit in a direction vertical to the detected gravitational direction.

7. The mobile communication terminal of claim 1, wherein the control unit adjusts the display direction of the information displayed on the display unit in a direction opposite to the detected rotational direction.

8. The mobile communication terminal of claim 7, wherein the control unit adjusts the display direction according to a detected rotational angle.

9. The mobile communication terminal of claim 1 wherein the information displayed by the display unit comprises at least one of a list of menu items, a character message, a data list, a moving picture and a still picture.

10. A method of displaying information in a mobile communication terminal, the method comprising:
detecting at least one of a gravitational direction of a display unit and a rotational direction of a display unit; and
adjusting a display direction of information displayed on the display unit using the detected at least one of the gravitational direction and the rotational direction.

11. The method of claim 10, further comprising:
setting an information display function according to a motion direction.

12. The method of claim 10, further comprising:
measuring at least one of remaining battery quantity, remaining memory quantity, call reception sensitivity, network reception sensitivity, amount of data downloaded and broadcast reception sensitivity.

13. The method of claim 12, further comprising displaying an indication of a size of the measurement performed as the information displayed on the display unit.

14. The method of claim 10, wherein detecting the at least one of the gravitational direction and the rotational direction comprises controlling a sensor.

15. The method of claim 10, wherein the display direction of the information displayed on the display unit is adjusted in a direction vertical to the detected gravitational direction.

16. The method of claim 10, wherein the display direction of the information displayed on the display unit is adjusted in a direction opposite to the detected rotational direction.

17. The method of claim 16, wherein the display direction of the information is adjusted according to an angle of detected rotation.

18. The method of claim 10, wherein the information displayed on the display unit comprises at least one of a list of menu items, a character message, a data list, a moving picture and a still picture.

19. A method of displaying information in a mobile communication terminal, the method comprising:
setting an information display function according to a motion direction;
displaying an indication of a size of a measurement performed on a display unit;
detecting at least one of a gravitational direction of the display unit and a rotational direction of the display unit; and
adjusting a display direction of the indication displayed on the display unit using the detected at least one of the gravitational direction and the rotational direction.

20. The method of claim 19, wherein the display direction of the indication is adjusted in one of a direction vertical to the detected gravitational direction and a direction opposite to the detected rotational direction.
